(19) United States
(12) Patent Application Publication
(10) Pub. No.: US 2026/0318104 A1
(43) Pub. Date: Oct. 15, 2026

(54) Illuminated Memorial Device

(71) Applicant: Joan Hester, Allen Park, MI (US)

(72) Inventor: Joan Hester, Allen Park, MI (US)

(21) Appl. No.: 19/177,933

(22) Filed: Apr. 14, 2025

(51) Int. Cl. E04H 13/00; F21S 9/03

(52) U.S. Cl. CPC E04H 13/001; F21S 9/037

(57) ABSTRACT

An illuminated memorial device includes a base having an upper surface. A bottom edge of the head is positioned on the base surrounding a portion of the upper surface. A lighting element is coupled to the base and positioned within the portion of the upper surface surrounded by the bottom edge of the head. A solar panel is positioned on the portion of the upper surface surrounded by the bottom edge of the head and is operationally coupled to the lighting element. The head is constructed of a material to permit transmission of light from outside of the head to the solar panel. Thus, the head shields the solar panel from debris while the solar panel is exposed to the light transmitted through the head.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention.

The disclosure relates to memorial devices and more particularly pertains to a new memorial device for enhancing appearance and recognition of a memorial tombstone.

### (2) Description of Related Art Including Information Disclosed Under 37 CFR 1.97 and 1.98

The prior art relates to memorial devices. Known prior art includes solar panels positioned in an exposed position on a top surface of a headstone or other memorial, and generally provides for lights to shine on exterior surfaces of the headstone or memorial. Known prior art lacks a sheltered position for solar panels.

### (h) BRIEF SUMMARY OF THE INVENTION

An embodiment of the disclosure meets the needs presented above by generally comprising a base having an upper surface. A bottom edge of the head is positioned on the base surrounding a portion of the upper surface. A lighting element is coupled to the base and positioned within the portion of the upper surface surrounded by the bottom edge of the head. A solar panel is positioned on the portion of the upper surface surrounded by the bottom edge of the head and is operationally coupled to the lighting element. The head is constructed of a material to permit transmission of light from outside of the head to the solar panel. Thus, the head is configured to shield the solar panel from debris while the solar panel is exposed to the light transmitted through the head.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of an illuminated memorial device according to an embodiment of the disclosure.

FIG. 2 is a top rear side perspective view of an embodiment of the disclosure.

FIG. 3 is a front view of an embodiment of the disclosure.

FIG. 4 is a top front side perspective view of an embodiment of the disclosure in use.

### (j) DETAILED DESCRIPTION OF THE INVENTION

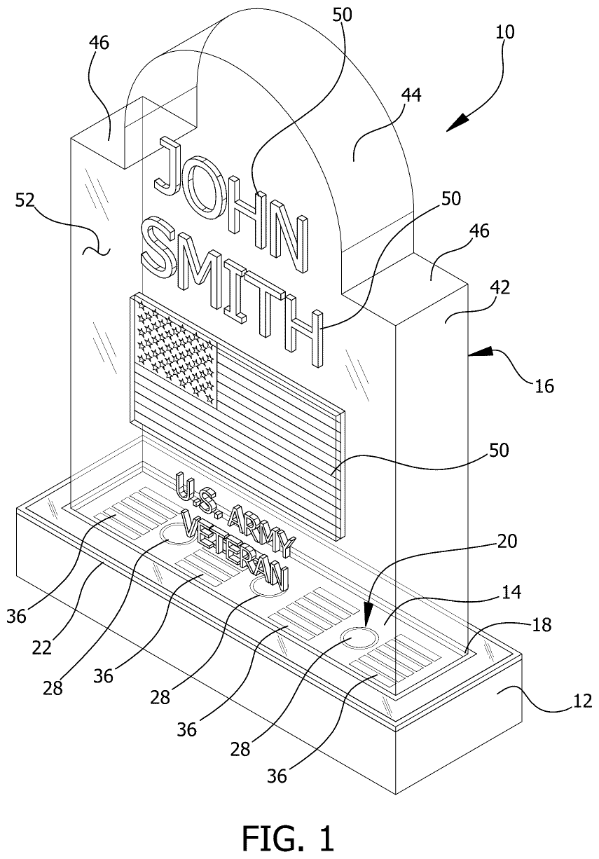

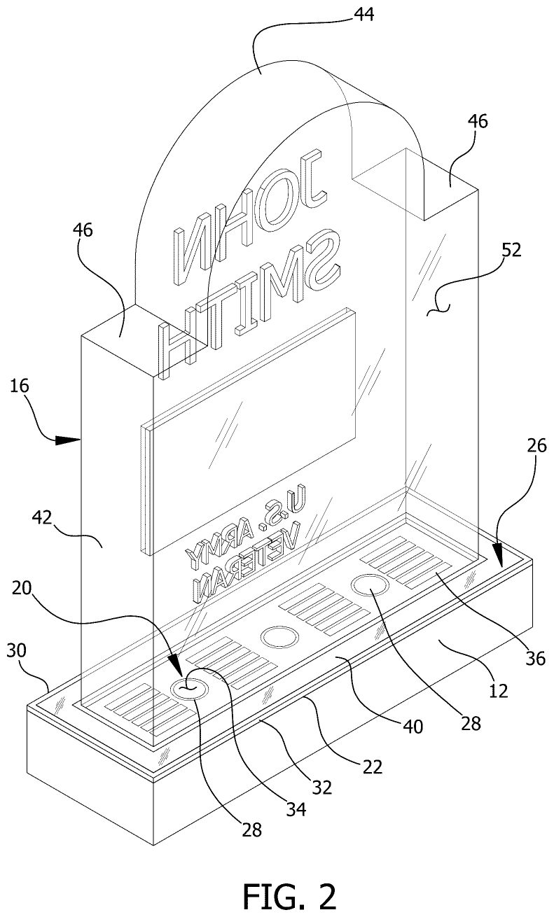

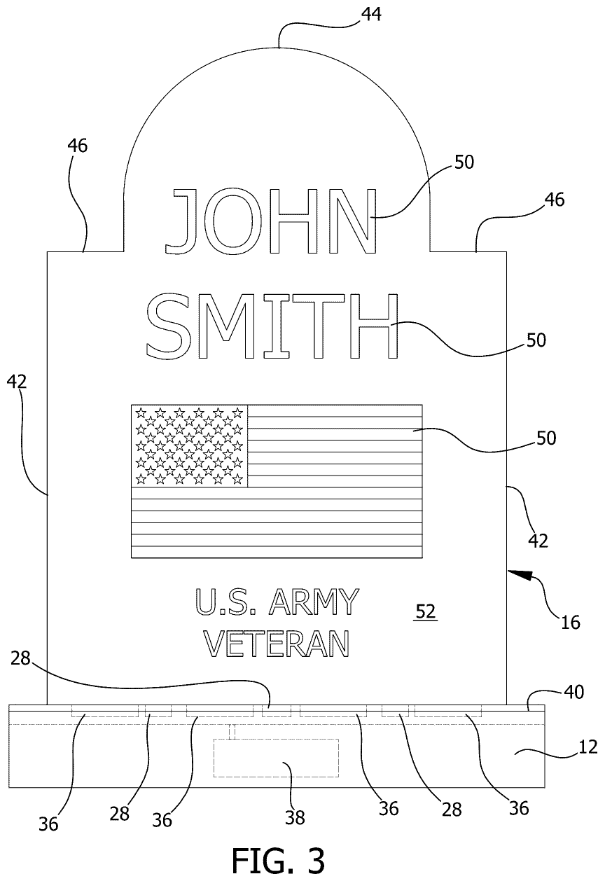

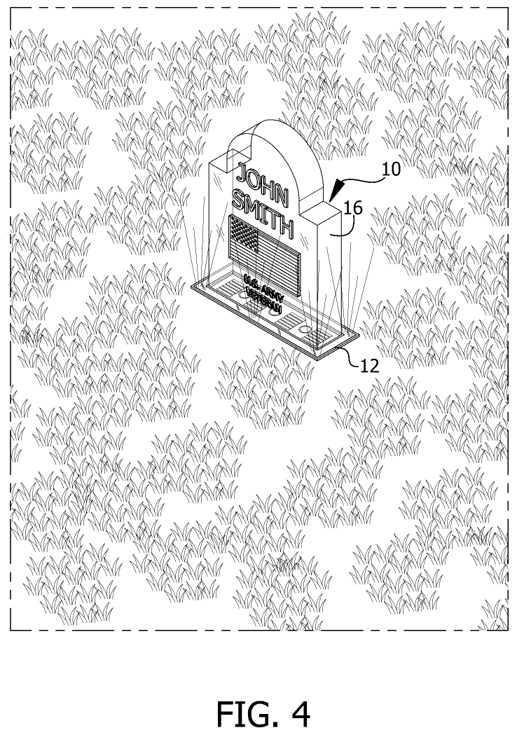

With reference now to the drawings, and in particular to FIGS. 1 through 4 thereof, a new memorial device embodying the principles and concepts of an embodiment of the disclosure and generally designated by the reference numeral 10 will be described.

As best illustrated in FIGS. 1 through 4, the illuminated memorial device 10 generally comprises a base 12 having an upper surface 14. A head 16 is coupled to the base 12. A bottom edge 18 of the head 16 is positioned on the base 12 surrounding a portion 20 of the upper surface 14. The bottom edge 18 of the head 16 is inset from a peripheral edge 22 of the upper surface 14 of the base 12 to define an outer peripheral portion 26 of the upper surface 14 of the base 12. Each of a plurality of lighting elements 28 is coupled to the base 12. Each lighting element 28 is positioned within the portion 20 of the upper surface 16 surrounded by the bottom edge 18 of the head 16. The plurality of lighting elements 28 is linearly aligned parallel to a front edge 30 and a rear edge 32 of the base 12. Each of the lighting elements 28 has a planar upper face 34 positioned flush with the upper surface 14 of the base 12. Each lighting element 28 may be a light bulb, a light emitting diode, or the like.

Each of a plurality of solar panels 36 is coupled to the base 12. Each solar panel 36 is positioned on the portion 20 of the upper surface 14 surrounded by the bottom edge 18 of the head 16. Each solar panel 36 is operationally coupled to the lighting elements 28. The plurality of solar panels 36 is positioned in linear alignment in an alternating pattern with the lighting elements 28. A battery 38 is positioned in the base 12 and electrically connected to the solar panels 36 and the lighting elements 28.

The head 16 is in the general form of a memorial or headstone but is constructed of a material which permits transmission of light from outside of the head 16 to the solar panels 36. Thus, the head 16 is configured to shield the solar panels 36 from debris while the solar panels are exposed to the light transmitted through the head 16.

A strip light 40 is coupled to the base 12. The strip light 40 is positioned on the outer peripheral portion 26 of the upper surface 14 of the base 12. The strip light 40 is operationally coupled to the solar panels 36. The strip light 40 fully encircles the head 16.

The head 16 has a pair of vertical planar side faces 42 and a semi-circular uppermost surface 44. The semi-circular uppermost surface 44 is centered between the vertical planar side faces 42. The head 16 has a pair of shoulder surfaces 46. Each shoulder surface 46 extends between the semi-circular uppermost surface 44 and an associated one of the pair of vertical planar side faces 42.

Indicia 50 is positioned on the head 16. The indicia 50 may be an integral formation on or into an outer surface 52 of the head 16. The indicia 50 may provide information conventional for a headstone or memorial such as name, dates, quotes, emblems, or the like. The indicia 50 is illuminated to be highlighted, backlit, or otherwise image enhanced by the illumination provided to the interior of the head 16 by the lighting elements 28.

In use, the base 12 is installed into ground such as in a cemetery or other memorial site. The head 16 may be previously attached to the base 12, or attached after installation of the base 12. The head 16 being either translucent or fully transparent allows for light to reach the solar panels 36 which are shielded from the elements and being covered by debris, snow, or the like. The lighting elements 28 beam light into the head 16 illuminating the head 16 and the indicia 50 particularly such that the indicia 50 is highlighted and visibility of the indicia 50 is enhanced.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An illuminated memorial device comprising:
a base having an upper surface;
a head coupled to said base, a bottom edge of said head being positioned on said base surrounding a portion of said upper surface;
a lighting element coupled to said base, said lighting element being positioned within said portion of said upper surface surrounded by said bottom edge of said head;
a solar panel coupled to said base, said solar panel being positioned on said portion of said upper surface surrounded by said bottom edge of said base, said solar panel being operationally coupled to said lighting element; and
wherein said head is constructed of a material which permits transmission of light from outside of said head to said solar panel wherein said head is configured to shield said solar panel from debris while said solar panel is exposed to the light transmitted through said head.

2. The illuminated memorial device of claim 1, further comprising indicia positioned on said head.

3. The illuminated memorial device of claim 1, further comprising said bottom edge of said head being inset from a peripheral edge of said upper surface of said base to define an outer peripheral portion of said upper surface of said base.

4. The illuminated memorial device of claim 3, further comprising a strip light coupled to said base, said strip light being positioned on said outer peripheral portion of said upper surface of said base.

5. The illuminated memorial device of claim 4, further comprising said strip light encircling said head.

6. The illuminated memorial device of claim 1, further comprising said lighting element being one of a plurality of lighting elements, said plurality of lighting elements being linearly aligned parallel to front and rear edges of said base.

7. The illuminated memorial device of claim 6, further comprising said solar panel being one of a plurality of solar panels, said plurality of solar panels being positioned in linear alignment in an alternating pattern with said lighting elements.

8. The illuminated memorial device of claim 6, further comprising each of said lighting elements having a planar upper face positioned flush with said upper surface of said base.

9. The illuminated memorial device of claim 1, further comprising said head having a pair of vertical planar side faces.

10. The illuminated memorial device of claim 1, further comprising said head having a semi-circular uppermost surface.

11. The illuminated memorial device of claim 10, further comprising:
said head having a pair of vertical planar side faces;
said semi-circular uppermost surface being centered between said vertical planar side faces; and
a pair of shoulder surfaces, each shoulder surface extending between said semi-circular uppermost surface and an associated one of said pair of vertical planar side faces.

12. An illuminated memorial device comprising:
a base having an upper surface;
a head coupled to said base, a bottom edge of said head being positioned on said base surrounding a portion of said upper surface, said bottom edge of said head being inset from a peripheral edge of said upper surface of said base to define an outer peripheral portion of said upper surface of said base;
a plurality of lighting elements coupled to said base, each lighting element being positioned within said portion of said upper surface surrounded by said bottom edge of said head, said plurality of lighting elements being linearly aligned parallel to front and rear edges of said base, each of said lighting elements having a planar upper face positioned flush with said upper surface of said base;
a plurality of solar panels coupled to said base, each solar panel being positioned on said portion of said upper surface surrounded by said bottom edge of said base, each solar panel being operationally coupled to said lighting element,, said plurality of solar panels being positioned in linear alignment in an alternating pattern with said lighting elements;
wherein said head is constructed of a material which permits transmission of light from outside of said head to said solar panel wherein said head is configured to shield said solar panel from debris while said solar panel is exposed to the light transmitted through said head;
a strip light coupled to said base, said strip light being positioned on said outer peripheral portion of said upper surface of said base, said strip light being operationally coupled to said solar panel, said strip light encircling said head;
said head having a pair of vertical planar side faces and a semi-circular uppermost surface, said semi-circular uppermost surface being centered between said vertical planar side faces, said head having a pair of shoulder surfaces, each shoulder surface extending between said semi-circular uppermost surface and an associated one of said pair of vertical planar side faces; and
indicia positioned on said head.
